(19) United States
(12) Patent Application Publication
(10) Pub. No.: US 2001/0052914 A1
(43) Pub. Date: Dec. 20, 2001

(54) SERVICE STATION DEVICE FOR INK-JET PRINTER

(76) Inventor: YONG-DUK LEE, KYUNGKI-DO (KR)

Correspondence Address: ROBERT E. BUSHNELL, ATTORNEY-AT-LAW, SUIE 300, 1522 "K" STREET, N.W., WASHINGTON,, DC, 200051202

(21) Appl. No.: 08/829,133

(22) Filed: Mar. 28, 1997

(30) Foreign Application Priority Data
Mar. 28, 1996 (KR) 96-6251
Mar. 17, 1997 (KR) 97-4873

(51) Int. Cl. B41J 2/165

(52) U.S. Cl. 347/29

(57) ABSTRACT

A service station device for an ink-jet printer is disclosed. This service station device cleans a nozzle of a head with a wiper on a housing, and seals with a cap on the housing, while the head is moved to the printer's service zone from a printing zone by a carriage. The service station device includes a cleaner having the movable wiper; a capping assembly operating to move the cleaner, and moving simultaneously with the cap's movement, thereby sealing the head's nozzle; and a locking member limiting the movement of the carriage making the capping assembly move, and controlling a release of the capping assembly's capping force.

### CLAIM OF PRIORITY

This application makes reference to, incorporates the same herein, and claims all benefits accruing under 35 U.S.C. §119 arising from an application for Service Station Device For Ink-Jet Printer earlier filed in the Korean Industrial Property Office on Mar. 28, 1996 and there duly assigned Ser. No. 6251/1996.

### FIELD OF THE INVENTION

The present invention relates to a service station device for an ink-jet printer which serves to clean and seal a nozzle of the printer's head. More particularly, it relates to a service station device for an ink-jet printer which may provide an effective seal to a head's nozzle with a cap's rotary motion and has the more improved capping function by restricting movement of a carriage for moving the printer's head during the printer's sleep mode of operation.

### DISCUSSION OF RELATED ART

There are many patents that discuss sealing and capping means for the nozzle of an ink-jet printer. For example, U.S. Pat. No. 5,471,230 for a Capping Means and Ink Jet Recording Apparatus Using The Same to Saito et al., U.S. Pat. No. 5,448,270 for an Ink-Jet Printhead Cap Having Suspended Lip to Osborne and U.S. Pat. No. 5,426,456 for a Suction and Covering Device For Suctioning Ink From Ink Print Heads of an Ink Jet Print Unit and For Sealing The Ink Jet Print Heads to Kuelzer et al. each discuss a means for capping a nozzle for an ink-jet printer to prevent leakage of ink. However, what is missing is a way for positioning the cap exactly to fit over the nozzle of an ink jet printer to prevent the unwanted leakage of ink when the nozzle is supposed to be capped. Also, what is not discussed is a mechanism for preventing the inadvertent detachment of the cap from the nozzle of the ink-jet printer if the ink-jet printer is inadvertently bumped or moved while the printer is not printing. In such a scenario, is desirable to have the cap remain attached to the nozzle so as to prevent the leakage of ink.

### SUMMARY OF THE INVENTION

Accordingly, the present invention is directed to a that substantially obviates one or more of the problems, limitations and disadvantages of the related art.

It is an objective to provide a service station device for an ink-jet printer which cleans a head's nozzle, exactly seals the nozzle with its cap, and then stops the cap from being removed from the nozzle, thus preventing ink loss.

Additional features and advantages of the invention will be set forth in the description which follows, and in part will be apparent from the description, or may be learned through practice of the invention. The objectives and other advantages of the invention will be realized through the structure, particularly as pointed out in the written description and claims hereof, as well as the appended drawings.

To achieve these and other advantages, and in accordance with the purpose of the present invention as embodied and broadly described, the following service station device is disclosed. That is, as its capping assembly's cap is moved upward by a carriage to seal a head's nozzle, the carriage's movement is automatically limited by a locking member.

The locking member's locking condition is automatically released as the carriage is moved to the printer's printing zone by starting the printing operation. This locking member is installed apart from the service station but is added as a system to the ink-jet printer, relating to the service station.

According to the construction of the present invention, the service station device for an ink-jet printer that cleans a nozzle of a head with a wiper on a housing, and seals with a cap on the housing, the head being moved to the printer's service zone from a printing zone by a carriage, the service station device includes a cleaner having the movable wiper; a capping assembly operating to move the cleaner, and moving simultaneously with the cap's movement, thereby sealing the head's nozzle; and a locking member limiting the movement of the carriage making the capping assembly move, and controlling a release of the capping assembly's capping force.

The cleaner includes a wiper body having the wiper and rotatable about wiper pivots, and the wiper body is moved downward when the capping assembly operates. The capping member includes a mobile member with the cap and a touch guide for transferring the carriage's moving force in the housing, and a spring for making the mobile member return to its original position, and the mobile member's one end, on which the cap is mounted, turns during the mobile member's capping operation. The mobile member includes first guide projections formed on both sides of its front part to be movable within upper straight-line races, formed on both sides of the housing, so as to make the mobile member's front part move horizontally during capping operation, and second guide projections formed on both sides of the mobile member's rear part and each inserted into lower sloping races, formed on both sides of the housing, so that the mobile member's rear part turns when the mobile member moves.

When the mobile member begins to move, the second guide projections on both sides of the mobile member's rear part that have supported the wiper body, are removed from the wiper body. When the locking member includes a locking snap piece that limits the movement of the carriage moving the head during the capping assembly's capping operation, a locking projection that is formed on the locking snap piece's tip and mates into a locking groove formed on the carriage, and an elastic member which allows elasticity to act toward the locking projection.

It is to be understood that both the foregoing general description and the following detailed description are exemplary and explanatory, and are intended to provide further explanation of the invention as claimed.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 schematically depicts a conventional ink-jet printer with printing and service zones;

FIG. 2 is a longitudinally-sectional view of a conventional service station device for an ink-jet printer;

FIG. 3 is a sectional view for describing the operating mechanism of the conventional service station device;

FIG. 4 is an exploded perspective view of a service station device for an ink-jet printer in accordance with the present invention;

FIG. 5 is a plan view of the service station device in accordance with the present invention;

FIG. 6 is a longitudinally-sectional view of a service station device for an ink-jet printer in accordance with the present invention;

FIG. 7 is a sectional view for describing the operating mechanism of the inventive service station device;

FIG. 8 is a sectional view as taken along line A-A′ of FIG. 6; and

FIG. 9 is a perspective view of a carriage locking member of FIG. 8.

### DETAILED DESCRIPTION OF THE INVENTION

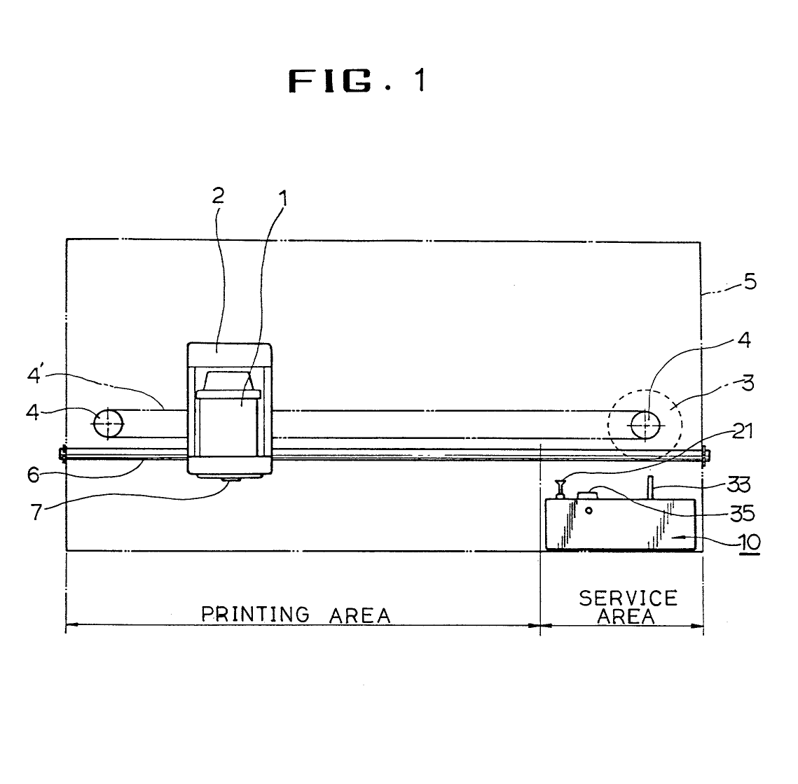

Turning to FIG. 1, in a conventional ink-jet printer a carriage 2, on which a head 1 is mounted, slides right and left by a timing pulley 4 and a belt 4′ driven by a forwarding/reversing motor 3. Carriage 2 makes a straight drive on under the guidance of a guide shaft 6 fixed on a main body frame 5.

Therefore, head 1 moves with carriage 2 and sprays ink particles on paper through a nozzle 7 under the control of the printer's control portion to form characters on paper in a dot-matrix format This printing operation is carried out in the printer's printing zone through which the paper passes. On one side of the printing zone, is a service zone formed having cleaning means of cleaning head 1's nozzle 7 according to a cleaning signal from the control portion, and a capping means of sealing nozzle 7, thus preventing ink loss. These cleaning means and capping means are contained in a service station device.

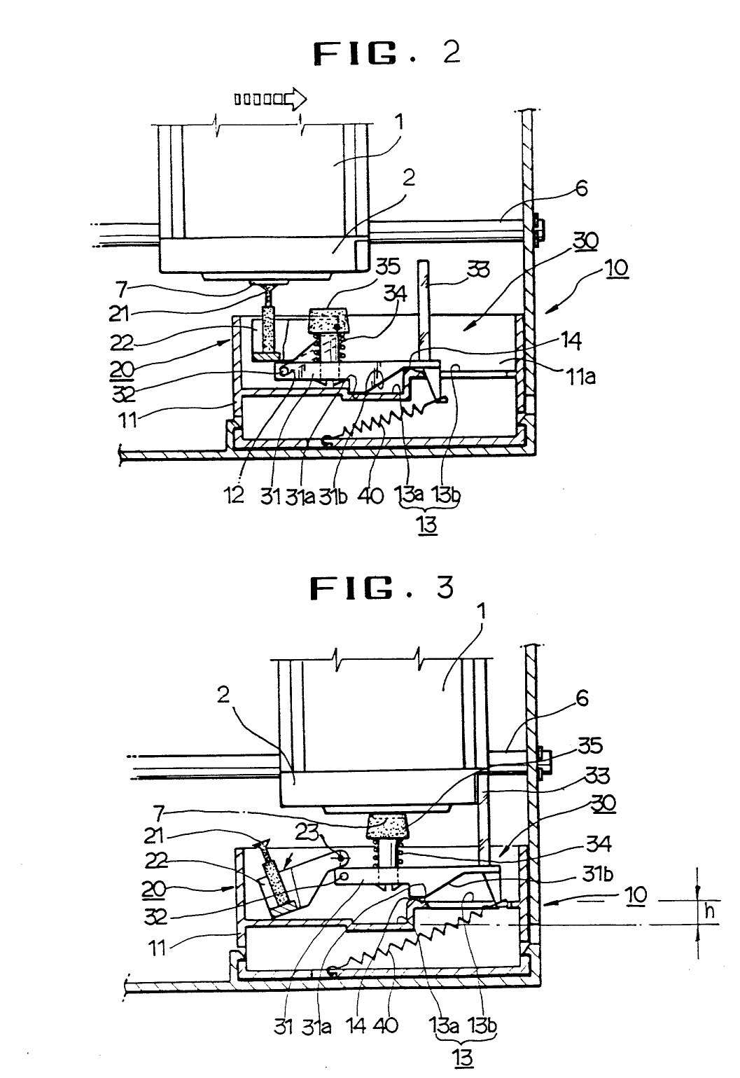

FIG. 2 is a conventional service station device 10. This service station device 10 has a housing 11 under a main body frame 5. Housing 11 is rectangular shaped, and has a rectangular space 11a in its interior, in which a cleaner 20 and a capping assembly 30 are installed. Cleaner 20 includes a wiper body 22 on which a wiper 21 made of rubber is fixedly mounted, and wiper body 22 is rotatable about a wiper pivot 23. Capping assembly 30 includes a mobile member 31 moved in space 11a, and guide projections 32 are formed on both sides of mobile member 31. A touch guide 33 is integrally formed on mobile member 31, opposite to guide projection 32 and extending upward, so that mobile member 31 is pushed by carriage 2. In addition, a cap 35 is installed on mobile member 31 so that a spring 34's elastic force acts upward.

Mobile member 31 is installed to move along guide grooves 12 formed on both sides of housing 11, and mobile member 31's lower portion 31a can move along a sliding face 13 formed inside of housing 10. Mobile member 31's lower portion 31a has an oblique section 31b. Sliding face 13 is formed to be stepped so that a lower sliding portion 13a and a higher sliding portion 13b are created. A round boss 14 is formed at a starting point of higher sliding portion 13b. Round boss 14 is designed to touch mobile member 31 minimally, and serves to smooth the movement of mobile member 31. Mobile member 31 is installed in space 11a to be pulled toward the printing zone by a spring 40 whose both ends are respectively caught by lower portion 31a and housing 11.

Mobile member 31 of service station device 10, where carriage 2 is positioned in the printing zone, remains at the printing zone by a drawing force of spring 40, as shown in FIG. 2. Lower portion 31a is positioned on lower sliding portion 13a. Wiper body 22 is put on mobile member 31, thus being horizontal. Service station device 10 operates when turning off the printer or when periodically cleaning head 1's nozzle 7. Carriage 2 having head 7 moves to the service zone.

When carriage 2 is moved, head 1's nozzle 7 passes on wiper 21 to clean nozzle 7, and such a cleaning operation is carried out in a moment while carriage 2 is moving. Right after cleaning nozzle 7, carriage 2 pushes touch guide 33 of capping assembly 30 to move mobile member 31 to right when viewed from FIG. 3.

Mobile member 31 comes to move upward, since its oblique section 31b is touching round boss 14 of higher sliding portion 13b during movement, and as carriage 2 stops, mobile member 31 stops moving, too. At this point, mobile member 31 is positioned on higher sliding portion 13b passing over round boss 14 of sliding face 13. Cap 35 is raised along with mobile member 31, thus sealing nozzle 7, and mobile member 31 supporting wiper body 22 is moved to right so that wiper body 22 turns downward about wiper pivot 23, and wiper 21 is not caught by head 1 or carriage 2. To prevent ink loss, cap 35 is not removed from nozzle 7 until carriage 2 is moved to the printing zone by resuming the printer.

In the conventional service station device 10 mobile member 31 is elevated, simultaneously with horizontally moving for the capping operation, and it must be designed precisely due to manufacturing tolerances, otherwise, cap 35 of mobile member 31, moving upward, may not exactly correspond to nozzle 7 of head 1 that moves to right, and cap 35 does not seal nozzle 7 perfectly, so ink becomes dry.

Particularly, mobile member 31 of the conventional service station device 10 has a big distance h of its elevation and descent. The larger distance h becomes, the more exactly sealing nozzle 7 with cap 35 is difficult. Therefore, the mobile member of a service station device is designed to have a small distance h, and it is not easy to make the mobile member have a stable distance of its elevation and descent because mobile member 31 moves along with carriage 2 to sea nozzle 7.

During the printer's sleep mode of operation, timing belt 4′ binding force acts on carriage 2, and this binding force is substantially small, thus allowing carriage 2 to slide right or left when moving the printer to another place. When sealing nozzle 7, carriage 2 moves toward the printing zone, and mobile member 31 moves toward the printing zone by spring 40. This makes so mobile member 31 move toward lower sliding portion 13a to thereby remove cap 35 from nozzle 7, which causes ink loss.

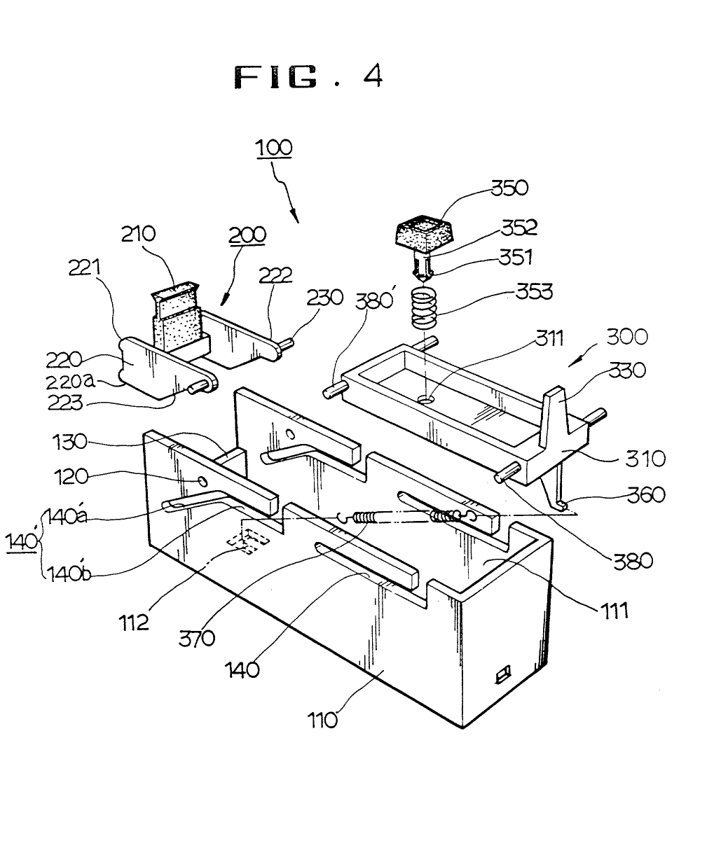

FIGS. 4 to 9 depict a service station device 100 for an ink-jet printer in accordance with the present invention.

Service station device 100 includes a housing 100 fixedly mounted in a service zone of a frame 5 of the printer's main body, a cleaner 200 movably installed within a space 111, a capping assembly 300 installed on one side of cleaner 200, sealing head 1's nozzle 7, and a locking member 400 preventing carriage 2 from moving simultaneously with capping assembly 300's sealing nozzle 7.

Housing 110 is injection-molded from plastic, and has space 111 so that cleaner 200 and capping assembly 300 can be moved in space 111. Cleaner 200 is installed on one side of housing 110.

More specifically, cleaner 200 is installed on housing 110's one side, i.e. housing 110's left side when viewed from the drawing of FIG. 5 so that cleaner 200's wiper 210 cleans head 1's nozzle 7 when head 1 begins to move to the service zone from the printing zone. Cleaner 200 consists of a wiper body 220 that is of size enough to securely fit into space 111 of housing 110, and wiper 210 which is formed at wiper body 220's free ends 221, being made of rubber.

Wiper pivots 230 are each formed on both pivot ends 222 of wiper body 220 opposite to free ends 221, and wiper pivots 230 securely fit into pivot holes 120 respectively formed on both sides of housing 110 so that wiper body 220's free ends 221 rotate about wiper pivots 230. Wiper body 220 has slant guide portions 223 under free ends 221, slantingly extending to pivot ends 222. A stopper 130 is integrally formed in housing 110 under wiper body 220's free ends 221 so as to control wiper body 220's downward rotation. Capping assembly 300 includes a mobile body 310 inserted into space 111, and a cap 350 on a spot of mobile body 310's top surface that is near wiper 210. Cap 350, made of rubber, is joined to a shaft 352's top having a catch 351 forced into a hole 311 formed on mobile body 310. Catch 351 is forced into hole 311 while a spring 353 is put on shaft 352 with cap 350 so that catch 351 is secured to mobile member 310's bottom. Cap 350 on shaft 352 always upwardly protrudes by spring 353, and it becomes a little pressed when it seals nozzle 7 of head 1, closing to nozzle 7. At this point, as spring 353 is being compressed, its elastic force is more increased to thereby press cap 350. Cap 350 strongly touches head 1's nozzle 7, thus sealing nozzle 7 more efficiently.

On mobile member 310's top surface, opposite to cap 350, is a touch guide 330 integrally formed, protruding upward, to be pushed by carriage 2's movement, and right under touch guide 330, is a spring barb 360 integrally formed. One end of spring 370 having elasticity for pulling mobile member 310 toward the printing zone, is caught by spring barb 360, and the other end of spring 370 is caught by a spring catching section 112 formed on housing 110. Guide projections 380 and 380′ are each formed on both front and rear sides of mobile member 310. There is no particular definition in the location of each of front and rear sides of mobile member 310, and the portion, where touch guide 330 is formed, is mobile member 310's front side, and the portion having cap 350 is its rear side.

As mobile member 310 fits into housing 110's space 11, guide projections 380 and 380′ are respectively inserted into upper straight-line races 140 and lower sloping races 140′ each having a sloping race 140′a and a lower straight-line race 140′b, formed on both sides of housing 110, respectively. When mobile member 310 fits into housing 110, guide projections 380′ are inserted into lower sloping races 140′ and positioned in each sloping race 140′a, so the rear side of mobile member 310, placed in housing 110′, becomes lower than its front side having touch guide 330.

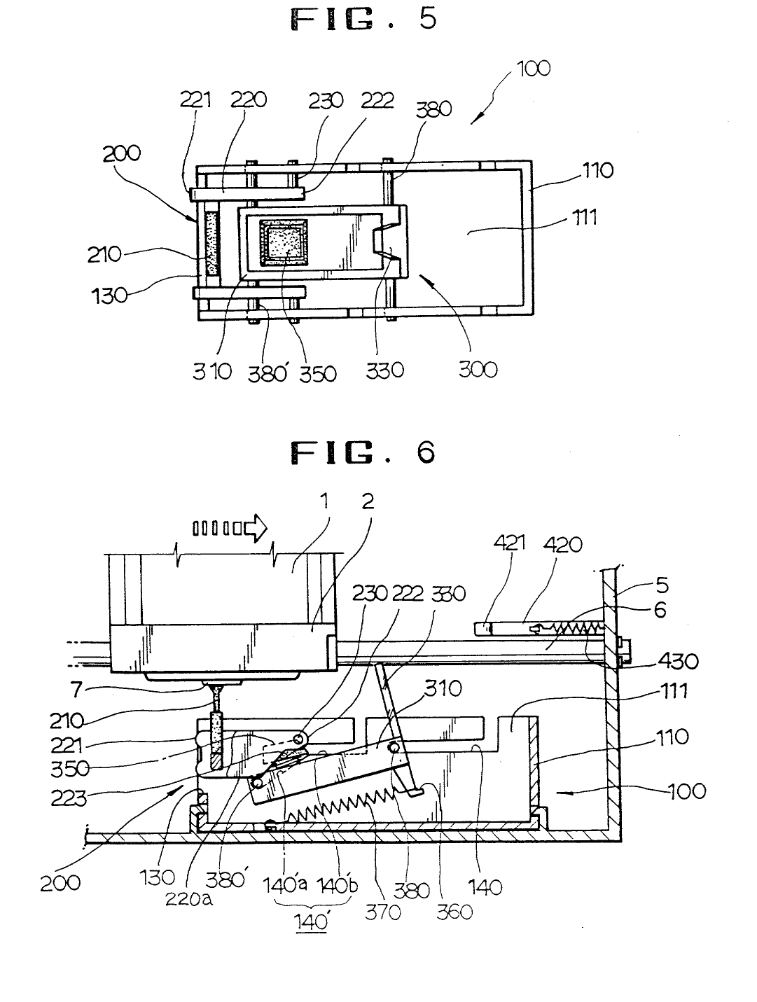

Referring to FIG. 6, mobile member 310 is moved toward the printing zone (left side when viewed from the drawing) by spring 370. FIG. 6 shows service station device 100 when head 1 and carriage 2 are in the printing zone. The lower end 220a of cleaner 200's wiper body 220 is being placed on guide projections 380′, so wiper body 220 becomes horizontal, which is maximally elevated.

Locking member 400, depicted in FIGS. 6, 8 and 9, serves to limit the movement of carriage which allows cap 350 to seal nozzle 7 and applies moving force for the capping operation. As shown in FIG. 8, locking member 400 consists of a locking snap piece 420 having a locking projection 421 that mates into or is removed from a locking groove 410 formed on carriage 2's rear portion, and an elastic member 430 whose elastic force acts toward locking projection 421.

Locking snap piece 420 is fixed to frame 5 of the service zone to which carriage 2 is moved, and elastic member 430's both ends are each connected to locking snap piece 420's middle and frame 5. Accordingly, in case of turning off the printer, or cleaning nozzle 7 periodically, carriage 2 on which head 1 is mounted, moves toward the service zone from the printing zone, and FIG. 6 shows the initial state of carriage 2 moving toward the service zone.

Head 1's nozzle 7 is cleaned by wiper 210 during carriage 2's movement, and as nozzle 7 is cleaned, carriage 2 continues moving so that its one part moves to the end of the service zone's traveling section, touching touch guide 330. According to touch guide 330's movement, mobile member 310 is moved within space 111 of housing 110.

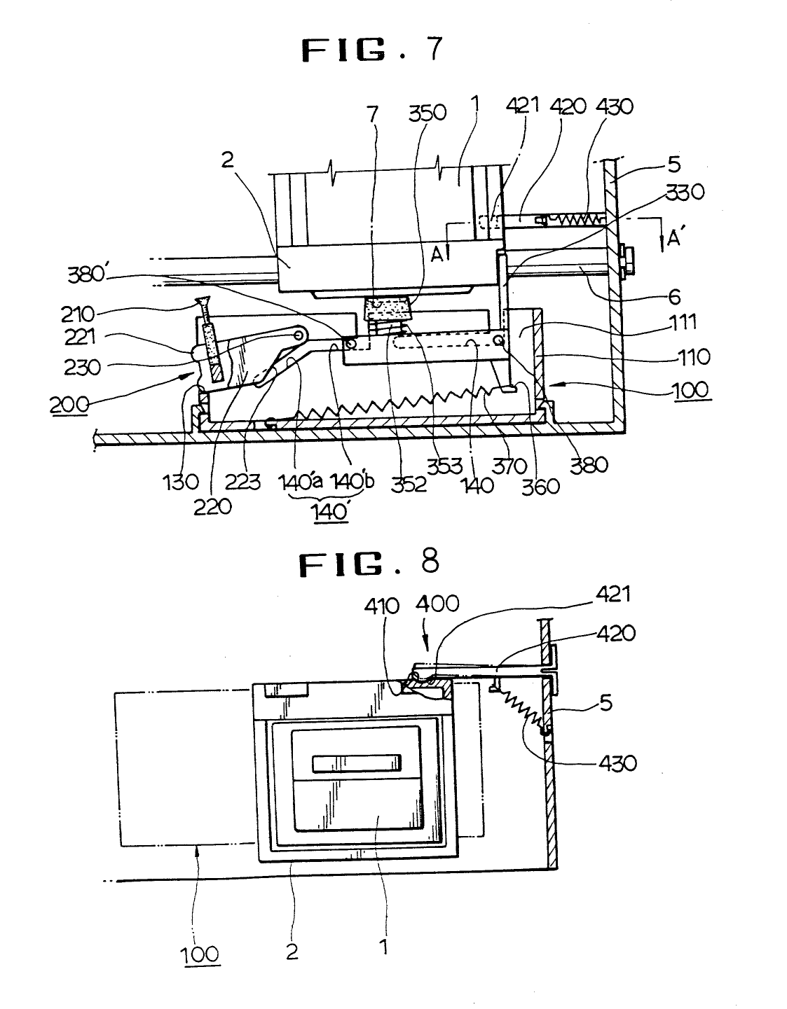

FIG. 7 shows mobile member 310 that is moved after cleaning nozzle 7, and mobile member 310's guide projections 380 and 380′ move within housing 110's upper straight-line races 140 and lower sloping races 140′. In other words, guide projections 380, formed on mobile member 310's front part, move rectilinearly along upper straight-line races 140.

Guide projections 380′, formed on mobile member 310's rear part, move along lower sloping races 140′. More specifically, when guide projections 380′ move along sloping races 140′a at first, mobile member 310's rear part moves upward, and as guide projections 380′ reach lower straight-lime races 140′b, mobile member 310 moves rectilinearly by the time carriage 2 stops.

Consequently, carriage 2's mobility acts on mobile member 310 so that mobile member 310's rear part moves upward, and accordingly, cap 350 comes to touch head 1's nozzle 7, thus sealing it. Where cap 350 meets nozzle 7, guide projections 380′ go up sloping races 140′a completely, and then travel straight. Cleaner 200 operates as capping assembly 300 performs the capping operation. That is, mobile member 310 moves by carriage 2, its guide projections 380′ become away from wiper body 220. As mobile member 310 moves, guide projections 380′, supporting wiper body 220, are removed therefrom. Since nothing limits wiper body 220, its free ends 221 move downward, and wiper 210 goes away from head 1 and carriage 2 right after cleaning nozzle 7, which prevents damage to wiper 210. As carriage 2 completely moves to the end of the service zone's traveling section and then stops, carriage 2's movement is limited by locking member 400.

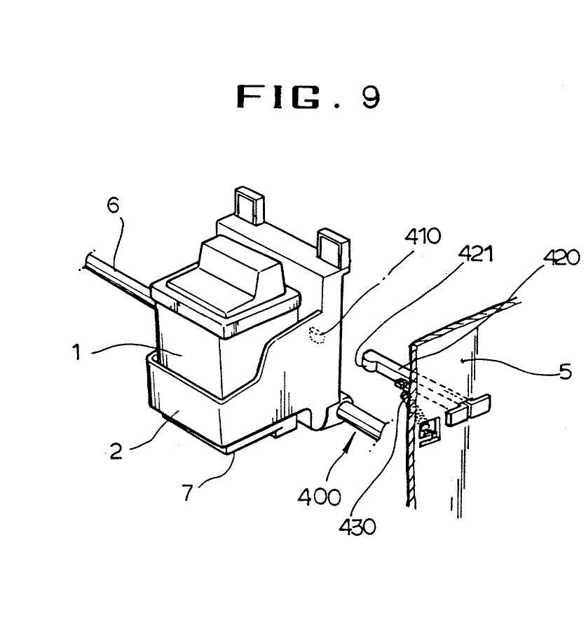

Referring to FIGS. 8 and 9, moving carriage 2 touches locking projection 421, so locking snap piece 420, holding locking projection 421, is pushed rearward. Once carriage 2 stops moving, locking snap piece 420 returns to its original position by elastic member 430, and locking projection 421 mates into locking groove 410.

The binding force for carriage 2, created by locking member 400, equals to the sum of locking snap piece 420's elastic force and elastic member 430's. Thus, this binding force depends on the material forming each of locking snap piece 420 and elastic member 430 and their elasticity, so the binding force for carriage 2 is set to be smaller than the feeding force of timing belt 4 which makes carriage 2 move.

When carriage 2 is moved to the printing zone by turning the printer on, timing belt 4's feeding force is larger than locking member 400's binding force so that locking projection 421 is removed from locking groove 410 naturally. Therefore, in case that outside shock is applied to carriage 2 of the printer in sleep mode of operation, due to the vibration created in the printer location, a user's careless handling, or movement of the printer into another place, the elasticity of each of locking snap piece 420 and elastic member 430 prevents dislocation of locking projection 421 and locking groove 410. In this manner, carriage 2's movement is limited, and the capping condition in which cap 350 is adhering to seal nozzle 7 can be maintained.

In case that carriage 2 is moved by one of the above causes, it is moved toward the printing zone, and spring 370's drawing force makes mobile member 310 move as carriage 2 moves. Accordingly, mobile member 310's guide projections 380′ may move along lower straight-line races 140′b, and its rear part is moved downward. At this point, cap 350 also moves with them, and is spaced away from, or slightly contacts or becomes completely removed from nozzle 7 of carriage 2 moving horizontally under the guidance of guide shaft 6, thus causing exposure of nozzle 7 to outside and ink loss.

In the inventive service station device 100 since carriage 2's movement is limited by locking member 400, carriage 2 does not slide during the printer's sleep mode of operation, so cap 350 goes on sealing nozzle 7, thereby preventing ink loss.

When turning on the printer, since carriage 2 has large moving force, it pushes locking projection 421 and locking snap piece 420, and carriage 2 in the service zone slides to the printing zone. Touch guide 330 becomes free from carriage 2, and mobile member 310 moves to left, the printing zone, by spring 370. Since mobile member 310's guide projections 380 and 380′ move within upper straight-line races 140 and lower sloping races 140′, respectively, mobile member 310's rear part having cap 350 moves downward again, so cap 350 is removed from head 1's nozzle. Since guide projections 380′ are moved to the bottom of wiper body 220 according to mobile member 310's movement, as guide projections 380′ push wiperbody 220, the respective wiper body 220's free ends 221 turn upward about wiper pivots 230, and cleaner 200 becomes horizontal, being supported by guide projections 380′, and is in ready-to-clean state (refer to FIG. 6).

When carriage 2 slides to the service zone, the service station device performs the above nozzle-cleaning & capping and carriage-locking operations again.

As described above, the service station device of the present invention not only cleans the head's nozzle but also seals it with the cap exactly, thus carrying out its function without error. In addition, the inventive service station device may limit the movement of the carriage with the head, SO stops the cap from being removed from the nozzle, thus preventing ink loss and deterioration in the printer performance. Therefore, the present invention provides an improvement in a service station device for an ink-jet printer and enhancement of product reliability.

It will be apparent to those skilled in the art that various modifications and variations can be made in the service station device for an ink-jet printer of the present invention without departing from the spirit or scope of the invention. Thus, it is intended that the present invention cover the modifications and variations of this invention provided they come within the scope of the appended claims and their equivalents.

What is claimed is:

1. A service station device for an ink-jet printer, comprising:
a printing head having a nozzle;
a carriage on which said printing head is located;
a cleaning means having a movable wiper;
a capping means operating to move the cleaning means, and moving simultaneously with the cap's movement, thereby sealing the head's nozzle; and
a locking means limiting the movement of the carriage making the capping means move, and controlling a release of the capping means' capping force.

2. A service station device according to claim 1, the cleaning means includes a wiper body having the wiper and rotatable about wiper pivots, and the wiper body is moved downward when the capping means operates.

3. A service station device according to claim 1, the capping means includes a mobile member with the cap and a touch guide for transferring the carriage's moving force in the housing, and a spring for making the mobile member return to its original position, and the mobile member's one end, on which the cap is mounted, turns during the mobile member's capping operation.

4. A service station device according to claim 3, the mobile member includes first guide projections formed on both sides of its front part to be movable within upper straight-line races, formed on both sides of the housing, so as to make the mobile member's front part move horizontally during capping operation, and second guide projections formed on both sides of the mobile member's rear part and each inserted into lower sloping races, formed on both sides of the lousing, so that the mobile member's rear part turns when the mobile member moves.

5. A service station device according to claim 3, when the mobile member begins to move, the second guide projections on both sides of the mobile member's rear part that have supported the wiper body, are removed from the wiper body.

6. A service station device according to claim 1, when the locking means includes a locking snap piece that limits the movement of the carriage moving the head during the capping means' capping operation, a locking projection that is formed on the locking snap piece's tip and mates into a locking groove formed on the carriage, and an elastic member which allows elasticity to act toward the locking projection.

7. A service station device for an ink-jet printer, comprising:
a printing head nozzle;
a wiper;
a cleaning means having a wiper body with the wiper, and the wiper body's free ends being rotatable about wiper pivots each formed on both pivot ends;
a capping means having first guide projections on its front side that are spaced away from second guide projections and each movable within upper straight-line grooves, the second guide projections on its rear side that are each movable within lower sloping grooves, and support the wiper body's lower portion or gets away therefrom, the cap sealing the head's nozzle, a mobile member with a touch guide moved by the carriage, and a spring making the mobile member return to its original position; and
a locking means having a locking snap piece fixed to a frame of the printer's main body, of which a locking projection mates into or is removed from a locking groove formed on the carriage's rear portion, and an elastic member pulling the locking projection toward the locking groove.

8. The service station device for an ink-jet printer of claim 7, said capping means seals said printing head nozzle exactly, thus preventing leakage of ink from said capping means.

9. An ink-jet printer, comprising:
a print head;
a carriage for moving said print head from a printing zone to a service station; and
a locker for locking said print head to said service station, preventing the inadvertent movement of said print head into said print zone caused by an outside shock applied to the carriage of said printer or the vibration created in the printer location, careless handling of said printer, or movement of the print head to another place.
